(19) United States
(12) Patent Application Publication
(10) Pub. No.: US 2009/0089091 A1
(43) Pub. Date: Apr. 2, 2009

(54) EXAMINATION SUPPORT APPARATUS, METHOD AND SYSTEM

(75) Inventor: Ryosuke SAWASAKI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/212,098

(22) Filed: Sep. 17, 2008

(30) Foreign Application Priority Data
Sep. 27, 2007 (JP) 2007-252005

(51) Int. Cl. G06Q 50/00; G06Q 10/00

(52) U.S. Cl. 705/2; 705/7; 705/11

(57) ABSTRACT

A medical image to be examined is displayed on a monitor of an examination support apparatus, and a doctor input a result of examination or image-interpretation through an operating section. A time measuring device measures a time taken for the doctor to complete the image-interpretation, and the measured time is compared with a standard interpretation time that is previously estimated according to the doctor and the kind of the examination. If the measured time is too short, an error alert is displayed, so that the doctor may reinterprets the displayed image. If the measured time is too long, the examination support apparatus judges it necessary to reexamine or reinterpret the image, and reports the need for reinterpretation along with the result of the image-interpretation.

### FIELD OF THE INVENTION

The present invention relates to an examination support apparatus, an examination support method and an examination support system, which are directed to support carrying out examinations done by interpreting images taken from an examined target.

### BACKGROUND OF THE INVENTION

Image-interpretation is a method of diagnosis based on medical images taken through an examination, which may be called the examination images. In a case where a large number of medical images are taken, for example through a mass examination, the image-interpretation is often carried out in two steps: all of the medical images are roughly observed in a primary stage to winnow the medical images down, and the winnowed images are finely observed in a secondary stage. That is, those medical images where some lesion or abnormality is found or it seems so are sorted out in the primary stage, and are reinterpreted in the secondary stage, which may be called secondary image-interpretation or reinterpretation.

If the primary image interpretation is carried out by a doctor alone, the doctor can overlook the affected site or abnormality. For this reason, the image-interpretation is sometimes done under a rule that every medical image must be observed by more than one doctor in the primary stage, and if at least one doctor judges it necessary, the medical image is subjected to the secondary image-interpretation regardless of other doctors' judgments. Japanese Patent No. 3228532 discloses an image-interpretation system that is directed to improve the efficiency of image-interpretation in a case where a group of doctors interpret a large number of examination images under the above-mentioned rule.

However, making the image-interpretation by a number of doctors will not simply improve the accuracy and reliability of the doctor's individual interpretation. Therefore, the possibility of overlooking the affected site or abnormality still remains. In order to minimize the overlook, it is desirable interpreting every examination image by as many doctors as possible, but in practice, such a resolution is hard to adopt in view of the personnel and the cost.

### SUMMARY OF THE INVENTION

A primary object of the present invention is to provide an examination support apparatus, an examination support method and an examination support system, which supports an examiner to carry out an examination based on an image, and prevents examiners from overlooking some abnormality in the image or other failures and thus improves the accuracy and reliability of the examination.

An examination support apparatus of the present invention comprises a display device for displaying an image to be examined; an input device for inputting a result of the examination based on the displayed image; a time measuring device for measuring a time taken for the examiner to complete the examination of the image; and a first judging device for judging adequacy of the examination on the basis of the time measured by the time measuring device and a standard examination time estimated for the examination of the image.

Preferably, the examination support apparatus of the present invention further comprises a second judging device for judging whether it is necessary to reexamine the image or not on the basis of the input result of the examination and a judgment about the adequacy of the examination by the first judging device. More preferably, the examination support apparatus of the present invention further comprises a notifying device for notifying another examination support apparatus that the second judging device judges it necessary to reexamine the image.

According to a preferred embodiment, the examination support apparatus further comprises a time storage device for storing standard examination times estimated for each individual examiner and each kind of examination, wherein the first judging device reads out the standard examination time for judgment from the time storage device according to the examiner of the image. More preferably, the examination support apparatus further comprises a revising device for revising the standard examination times stored in the time storage device, the revising device revising the standard examination time as stored for the examiner and the kind of the examination of the image by use of the time measured by the time measuring device.

According to another preferred embodiment, the examination support apparatus further comprises a device for detecting a gazing point of the examiner and tracking whether the gazing point is in an image area of the image display device while the image is being displayed in the image area, wherein the time measuring device measures a total time length of the gazing point being in the image area during the examination of the image, and the first judging device uses the total time length as an effective examination time of the image for the judgment.

According to a further preferred embodiment, the examination support apparatus further comprises a device for detecting a gazing point of the examiner and tracking which segment of an image area of the image display device the gazing point is in, while the image is being displayed in the image area, wherein the time measuring device measures a respective time length of the gazing point being in each of the segments of the image area during the examination of the image, and the first judging device makes the judgment by use of the respective time lengths measured.

It is also preferable to provide the examination support apparatus with an alerting device for alerting an error in operation of the input device on the basis of the judgment by the first judging device.

Note that the image to be examined can be a medical image taken by a modality, and that the examination can be an image-interpretation.

An examination support system of the present invention comprises an image storage device storing a plurality of images to be examined; a plurality of examination support apparatuses, each comprising a display device that seriatim obtains one image from the image storage device and displays the image; an input device for inputting a result of the examination based on the displayed image; a time measuring device for measuring a time taken for the examiner to complete the examination of the displayed image; a first judging device for judging adequacy of the examination on the basis of the time measured by the time measuring device and a standard examination time estimated for the examination of the image; and a second judging device for judging whether it is necessary to reexamine the image or not on the basis of the input result of the examination and a judgment about the adequacy by the first judging device; and a report storage device storing reports relating to examinations based on respective images, each report including a result of examination based on each individual image and a judgment by the second judging device.

Preferably, the examination support system further comprises a notifying device that refers to each report stored in the report storage device and notifies another examination support apparatus of a need to reexamine the image.

An examination supporting method comprises steps of:

displaying an image to be examined;

measuring a time taken for an examiner to complete an examination of the displayed image;

estimating a standard examination time for the examination of the displayed image; and

judging adequacy of the examination on the basis of the measured time and the standard examination time.

According to the present invention, the adequacy of the examination is judged on the basis of the measured time, i.e. the time actually taken for the examination, and the standard examination time estimated for the examination. If the measured time is too short or too long in comparison with the standard examination time, the examination support apparatus judges the examination inadequate. Thereby, an operational error or another failure during the examination is checked up, so that the reliability of the examination is improved. Judging the need of reexamining the image by the examination result and the judgment on the adequacy of the examination effectively prevents overlooking some abnormality in the image and thus improves the accuracy of the examination.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram schematically illustrating a structure of an image-interpretation apparatus embodying an examination support apparatus of the present invention;

FIG. 2 is an explanatory diagram illustrating an example of an image display screen;

FIG. 3 is a block diagram illustrating an internal structure of the image-interpretation apparatus;

FIG. 4 is an explanatory diagram illustrating an example of contents registered in a standard time database;

FIG. 5 is an explanatory diagram illustrating an example of a result input screen;

FIG. 6 is an explanatory diagram illustrating an example of an error alert screen;

FIG. 7 is an explanatory diagram illustrating an example of a time-over alert screen;

FIG. 8 is a flowchart illustrating a sequence of overall operations of the image-interpretation apparatus;

FIG. 9 is an explanatory diagram illustrating an example of report records registered in a report database;

FIG. 10 is a flowchart illustrating a revising process for revising a standard interpretation time based on a measured interpretation time;

FIG. 11 is a perspective view of a monitor provided with a gazing point detector for detecting an interpreting doctor's gazing point on the monitor;

FIG. 12 is an explanatory diagram illustrating an image area of an image display screen of the monitor with the gazing point detector;

FIG. 13 is a block diagram illustrating a structure of an image-interpretation apparatus that tracks a gazing point on the monitor;

FIG. 14 is a flowchart illustrating an example of a process for judging adequacy of the interpretation by a total time length for which the gazing point exits in the image area;

FIG. 15 is an explanatory diagram illustrating another example of an image area on an image display screen, which is divided into segments for measuring interpretation times on the respective segments;

FIG. 16 is a flowchart illustrating an example of a process for judging adequacy of the interpretation by the interpretation times on the respective segments;

FIG. 17 is an explanatory diagram illustrating an embodiment configured as a medical network system; and

FIG. 18 is a flowchart illustrating a procedure for dual-interpretation.

### DESCRIPTION OF THE PREFERRED EMBODIMENTS

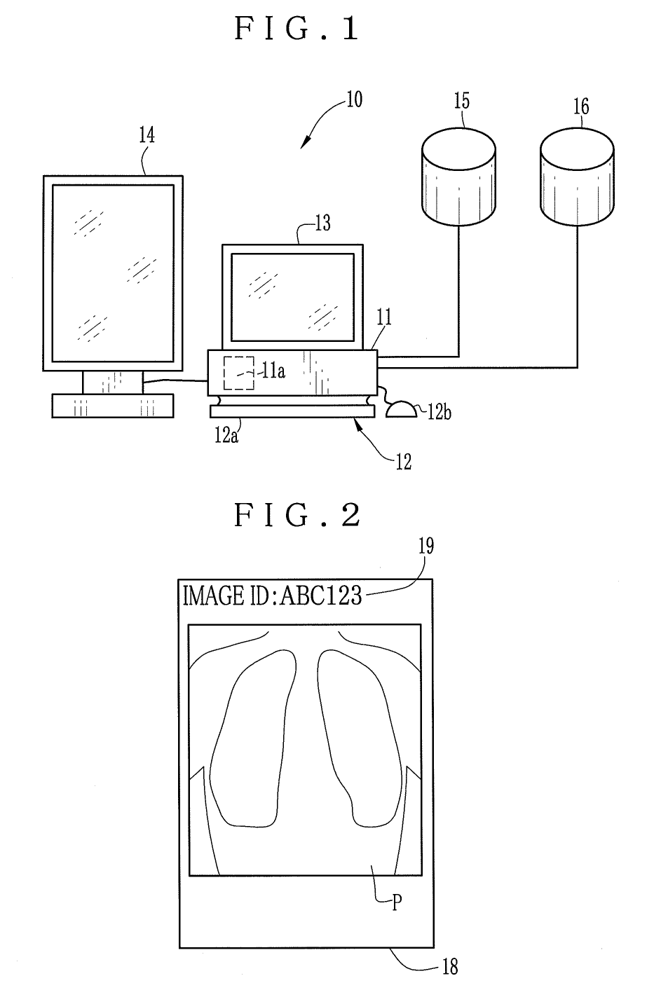

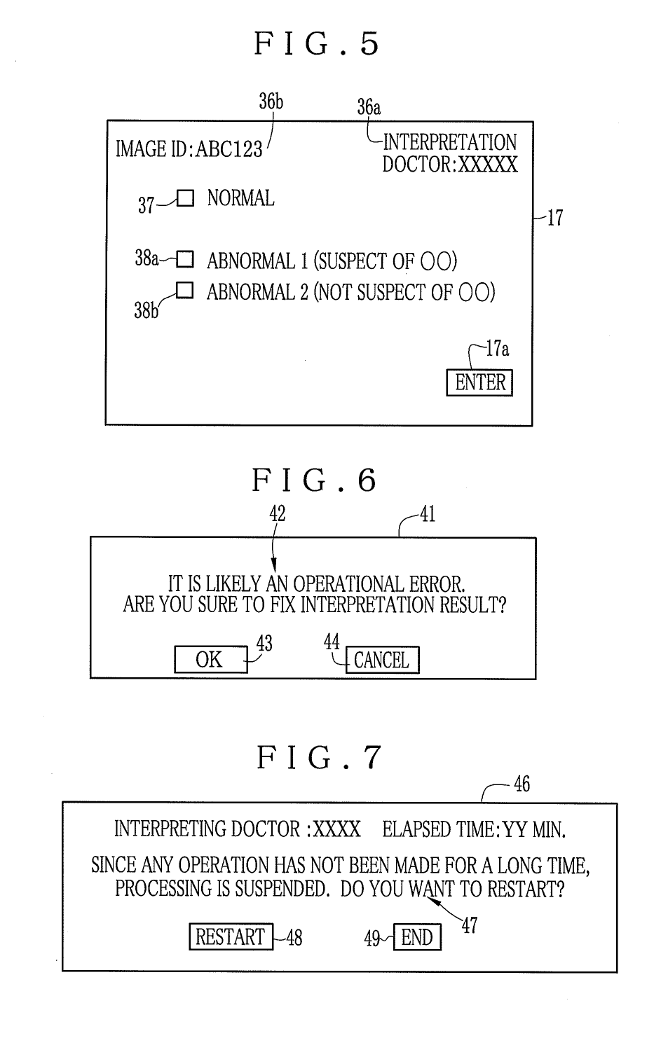

FIG. 1 shows an image-interpretation apparatus 10 as an embodiment of an examination support apparatus of the present invention. The image-interpretation apparatus 10 consists of a processor section 11, an operating section 12, monitors 13 and 14, storages 15 and 16. The image-interpretation apparatus 10 displays a result input screen 17 (see FIG. 5) on one monitor 13, and an image display screen 18 (see FIG. 2) on the other monitor 14. A doctor or operator interprets a medical image displayed on the monitor 14, and inputs a result of the image-interpretation on the result input screen of the monitor 13 through the operating section 12, thereby to make a report containing the interpretation result.

The processor section 11, the operating section 12 and the monitor 13 may be configured as those of a personal computer or the like. The processor section 11 is constituted of a CPU, memory devices, various interface circuits and so forth, which are not shown but built in a framing. A hard disc drive 11a is also incorporated in the processor section 11, storing OS and an image-interpretation support program. The CPU executes the image-interpretation support program to function the processor section 11 as the image-interpretation apparatus 10.

The operating section 12 consists of a keyboard 12a and a mouse 12b, and various information and commands necessary for image-interpretation are fed to the image-interpretation apparatus 10 by operating the operating section 12. Because the image-interpretation apparatus 10 of the present embodiment is designed for image-interpretation of a large number of medical images taken through mass examinations, for example, a graphical user interface (GUI) is adopted for the sake of improving efficiency of image-interpretation, so the main operations can be carried out by use of the mouse 12b.

The monitor 14 is an image display device for displaying the image display screen 18, as shown for example in FIG. 2. The image display screen 18 displays a medical image P as a subject of interpretation and an image ID 19 identifying the displayed image P. The doctor in charge of image-interpretation observes the medical image P on the monitor 14, and inputs an interpretation result on the result input screen 17.

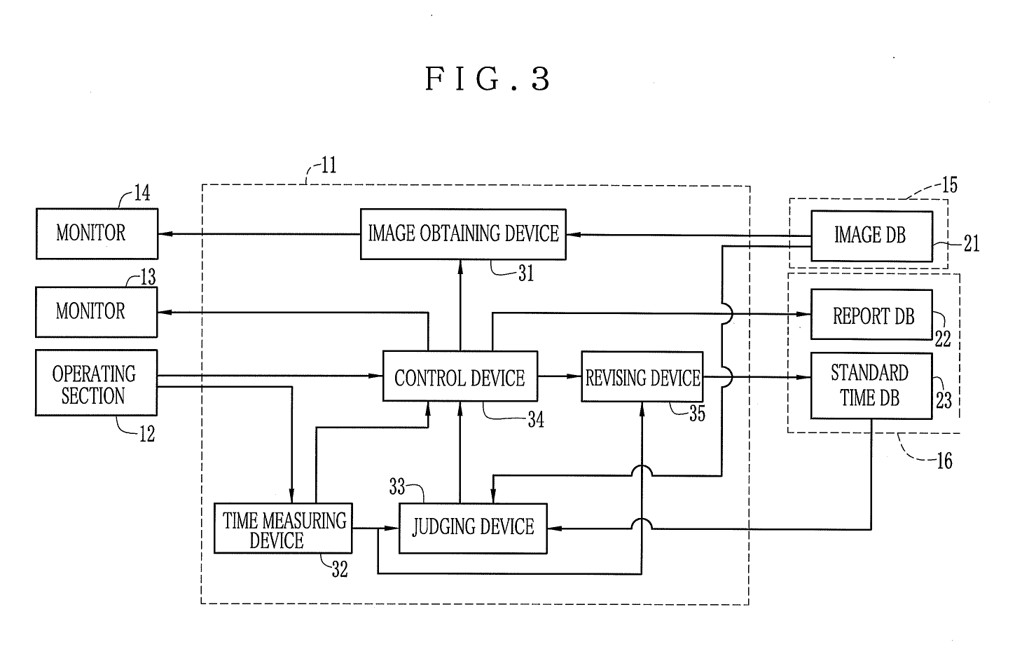

The storages 15 and 16 are large-scale hard discs. The storage 15 is an image storage device storing medical images P as subjects of interpretation, and an image database (DB) 21 is incorporated therein, as shown in FIG. 3. In the image database 21 are registered a large number of image records, each consisting of the medical image P and various information relating to the medical image P, including the corresponding image ID and patient ID. During the image-interpretation, the processor section 11 reads the image record one by one from the image database 21. Note that the medical images are taken, for example, by radiographic apparatuses, CT scanners and MRI scanners, and are digitalized and registered in the image database 21 by a not-shown register.

The storage 16 is a storage device, in which a report database 22 and a standard time database 23 are incorporated, as shown in FIG. 3. The report database 22 stores the reports produced by the processor section 11 and the standard time database 23 stores data of standard interpretation times that are estimated to be taken for interpretation of one medical image. The data of standard interpretation time is served for a judgment about the time taken for image-interpretation, as will be described in detail later.

In the report database 22 are registered report records, each of which contains a result of interpretation about one medical image P, a time length taken for the interpretation of the one medical image P, and a judgment as to whether reinterpretation of the one medical image is necessary or not. The report record is produced by the processor section 11 each time an interpretation process of one image is complete, and is registered in the report database 22 in association with the corresponding image ID. The registered report record is utilized for writing a diagnosis or for judging whether the reinterpretation is necessary or not.

FIG. 3 shows functional blocks of the processor section 11. As executing the above-mentioned image-interpretation support program, the processor section 11 functions as an image obtaining device 31, a time measuring device 32, a judging device 33, a control device 34 and a revising device 35.

The image-interpretation result is input through the operating section 12. For example, the mouse 12b is operated to enter a judgment as to whether any abnormality is found or not. Also through the operating section 12, the doctor in charge of the represent image-interpretation inputs information on him- or herself, a command for starting interpretation, a command for fixing the interpretation result, a command responding to an alert given by the image-interpretation apparatus 10, and other data and commands.

The image obtaining device 31 reads out one medical image P from the image database 21, to display it on the monitor 14. The image obtaining device 31 reads out the medical image P at first in response to the command for starting the image-interpretation entered through the operating section 12, but as for the next and following medical images P, the image obtaining device 31 reads it out in response to the command for fixing the interpretation result of the previous image. Thereby, work efficiency of examination is improved.

The time measuring device 32 measures the time length taken for interpreting each individual medical image P. For example, the time measuring device 32 is constituted of a timer circuit incorporated in the processor section 11, and measures the interpretation time of one image, starting from a time when the result input screen 17 is displayed on the monitor 13 and ending at a time when an enter button 17a (see FIG. 5) is operated to fix the input interpretation result.

The starting and ending points of measuring the interpretation time are not limited to the above-described embodiment, but any timing is applicable instead insofar as it can be held to represent the time length taken for image-interpretation of one image. For example, the starting point may be a time when one medical image P is actually displayed on the monitor 14, or the ending point may be a time when the choice between abnormal and normal is made as the interpretation result of the medical image P.

The judging device 33 makes a judgment as to whether the interpretation result of each individual medical image P is reliable or adequate or not, by comparing the actual interpretation time measured by the time measuring device 32 with the standard interpretation time stored in the storage 16. Since the interpretation time varies depending upon the kind of examination the medical images were obtained, e.g. the imaging direction and the examined site, as well as the skill of the doctor who takes charge of the image-interpretation and the procedure of the image-interpretation the doctor adopted, different values are predetermined to be the standard interpretation times for different kinds of examinations as well as for different doctors, and are registered in the standard time database 23 classified by the examination kinds and the doctors. The judging device 33 reads out the standard interpretation time according to the doctor who made the image-interpretation and the kind of examination by which the interpreted image was taken.

With reference to the read standard interpretation time, the judging device 33 judges the reliability of the interpretation result. Concretely, the judging device 33 compares the measured interpretation time with an upper limit and a lower limit, which are derived from the standard interpretation time. For example, the upper and the lower limits are calculated to be a certain percent, e.g. 15%, longer and short than the standard interpretation time. It is also possible to decide the upper and lower limits statistically.

In the present embodiment, the judging device 33 judges the interpretation result to be adequate and reliable when the measured interpretation time is within a normal range that is from the lower limit to the upper limit. If the measured interpretation time is longer than the upper limit, or shorter than the lower limit, the judging device 33 judges the interpretation result to be inadequate or unreliable. Note that the judgment about the interpretation result by the interpretation time does not always coincide with the validity of the interpretation result. If the judging device 33 judges the result to be unreliable, it implies a possibility that the interpretation can be invalid. For example, even if the conclusion is “normal”, if the interpretation time is longer than the upper limit, the interpretation result is judged to be suspicious.

The control device 34 controls judgment as to whether reinterpretation is necessary or not, recording of the report record in the report database 22, and displaying various alerting messages, respectively on the basis of inputs through the operating section 12 and the result of judgment by the judging device 33. The control device 34 constitutes a result controlling device that produces a report record for each individual medical image P and registers the report record in the report database 22, wherein the report record includes an interpretation result input through the operating section 12, a judgment by the judging device 33 and the judgment about the need for reinterpretation.

The need for reinterpretation is judged by the control device 34 through a need-for-reinterpretation judging process, which is executed when the operator or doctor makes an operation to fix the interpretation result. In the need-for-reinterpretation judging process, if the interpretation time is within the normal range, the need for reinterpretation is judged by the input interpretation result. That is, if the interpretation result shows that a medical image P has some abnormality, the control device 34 judges it necessary to reinterpret the medical image P. If the interpretation result of a medical image P is “normal”, the control device 34 judges it unnecessary to reinterpret the medical image P.

If the interpretation time for a medical image P is longer than the upper limit of the normal range, the control device 34 judges it necessary to reinterpret the medical image P, regardless of the input interpretation result. This is because the too long interpretation time may have some reason that should be examined, for example, that the medical image P contains some spot that attracts attention as it looks or looks like a lesion or nidus, or that the medical image P is somewhat unclear.

If the interpretation time for a medical image P is shorter than the lower limit of the normal range, an error alert screen is displayed on the monitor 13, alerting a probability of an operational error. On the error alert screen, the doctor in charge should make a choice, either reconfirming the interpretation result or restarting interpretation of the same medical image P. If the interpretation result is reconfirmed, the need for reinterpretation is judged by the input interpretation result, like in the case where the interpretation time is within the normal range.

However, it is alternatively possible to judge the reinterpretation to be necessary if the interpretation time is shorter than the normal range, regardless of the input interpretation result.

The control device 34 also monitors the time length as being measured by the time measuring device 32 till the operation for fixing the interpretation result is made, so that the control device 34 displays a time-over alert screen on the monitor 13 when the time measured by the time measuring device 32 gets over a threshold length that is predetermined to be longer than the upper limit of the normal range of the interpretation time. If the time-over alert screen is displayed, the interpreting doctor who is in charge of interpretation or another doctor or operator can choose either restarting the image-interpretation or terminating the image-interpretation. This way, even while the doctor in charge of the image-interpretation is absent or doing another job for a long time, data-locking of the medical image P that is presently displayed on the monitor 14 is avoidable by choosing the termination of the image-interpretation. Being data-locked, the presently displayed medical image P cannot be utilized by another apparatus.

The revising device 35 revises the standard interpretation time on the basis of the measured interpretation time. Every time the interpretation of one medical image P is complete, the revising device 35 captures the interpretation time measured by the time measuring device 32, and revises the corresponding standard interpretation time on the basis of the measured interpretation time. That is, such a standard interpretation time that corresponds to the measured interpretation time with respect to the interpreting doctor as well as the kind of the examination through which the interpreted medical image P was taken, e.g. X-ray imaging direction and imaged site.

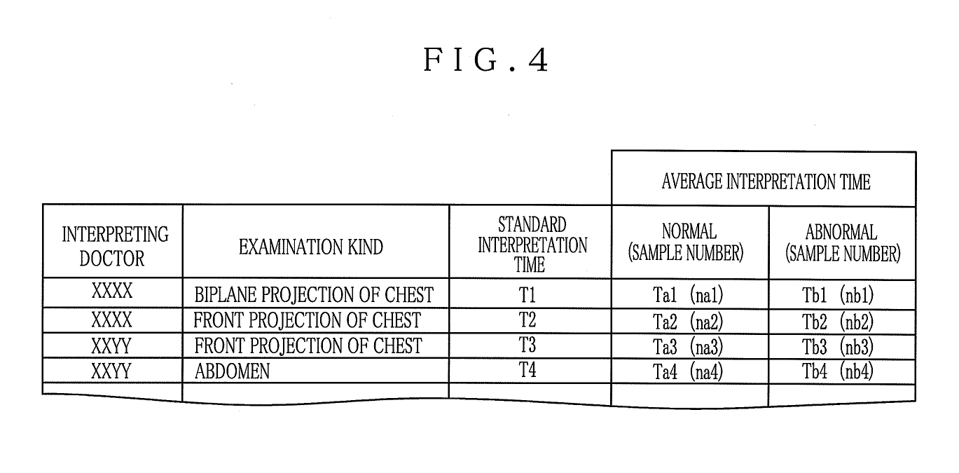

As shown for example in FIG. 4, the standard time database 23 stores a standard interpretation time Ti (i=1,2,3 . . . ), a first average interpretation time Tai (i=1,2,3 . . . ) and the sample number nai (i=1,2,3 . . . ) of those images which were interpreted as normal, a second average interpretation time Tbi (i=1,2,3 . . . ) and the sample number nbi (i=1,2,3 . . . ) of those images which were interpreted as having some abnormality. The sample number is the number of images that were actually subjected to the image-interpretation. To judge the adequacy of the interpretation, the standard interpretation time Ti is read out from the standard time database 23 in accordance with the interpreting doctor and the examination kind.

The standard interpretation time Ti is, for example, a total average interpretation time that is calculated on the basis of the average interpretation times Tai and Tbi and the sample numbers nai and nbi: Ti=(Taixnai+Tbixnbi)/nai+nbi. It is of course possible to define the standard interpretation time Ti according to another statistic method, and store information necessary for this method in a storage device. In that case, as the total average interpretation time is used as the standard interpretation time Ti, it is unnecessary to store the respective average interpretation times grouped by the interpretation results.

To revise the standard interpretation time Ti, the revising device 35 first revises either the first average interpretation time Tai and its sample number nai, or the second average interpretation time Tbi and its sample number nbi, depending upon whether the interpretation result refers to no abnormality or some abnormality and, thereafter, revises the standard interpretation time Ti on the basis of the average interpretation times Tai and Tbi and the sample numbers nai and nbi. According to the present embodiment, the revising device 35 does not revise the standard interpretation time Ti when the measured interpretation time is longer than the upper limit.

FIG. 5 illustrates an example of the result input screen 17 displayed on the monitor 13. The result input screen 17 shows the name of an interpreting doctor 36a and an image ID 36b, and has check boxes 37, 38a and 38b, and the enter button 17a. By clicking the mouse 12b on the check box 37, 38a or 38b, one of three choices is input as an interpretation result, and the input result is fixed by clicking on the enter button 17a.

FIG. 6 illustrates an example of the error alert screen 41 that is displayed on the monitor 13 when the measured interpretation time is shorter than the lower limit. On the error alert screen 41, an error warning massage 42, an OK button 43 and a cancel button 44 are displayed. The error warning message 42 warns the possibility of an operational error, and asks whether the input interpretation result is to be fixed or not. By clicking on the OK button 43, the interpretation result, which has been suspended since the enter button 17a was operated, is actually fixed and contained in the report record. If the cancel button 44 is clicked on, the result is canceled, and the process for interpreting the same medical image P restarts again, displaying the result input screen 17 for this medical image P again.

FIG. 7 shows an example of the time-over alert screen 46 that is displayed when the measured interpretation time gets over the threshold length. On the time-over alert screen 46, the interpreting doctor's name or ID, the elapsed time, a message 47, a restart button 48 and an end button 49 are displayed. The message 47 notices that the processing is suspended, and asks whether to restart the processing for image-interpretation or terminate it. By clicking on the restart button 48, the processing is restarted. By clicking on the end button 49, the processing is terminated.

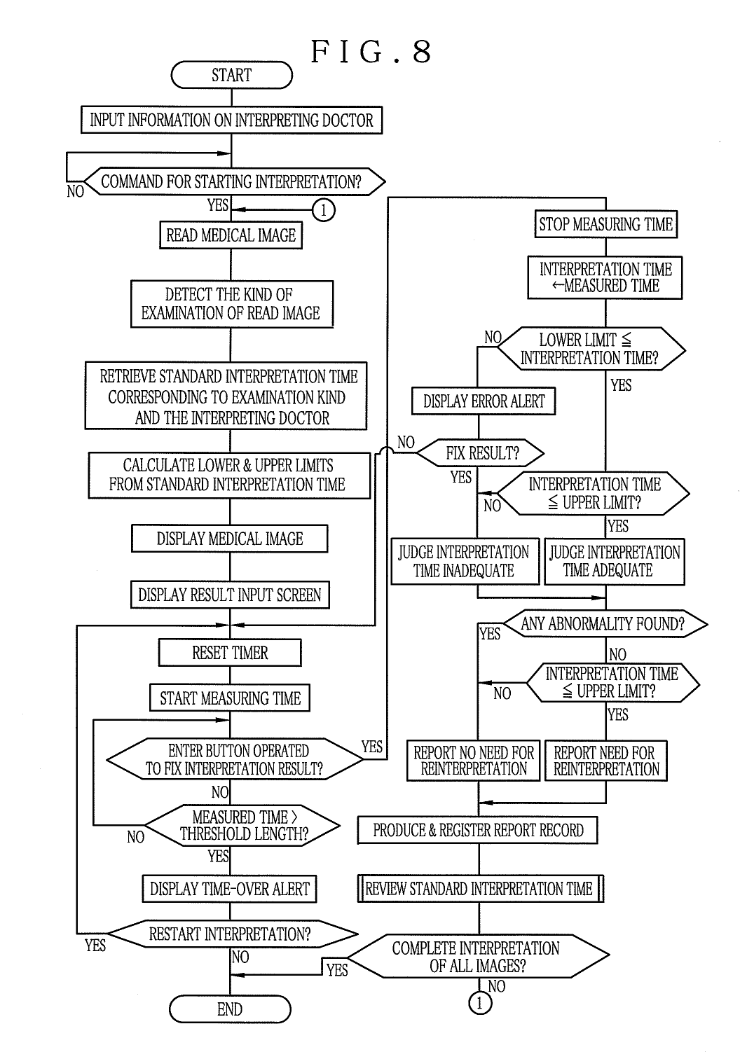

Now the operation of the above-described image-interpretation apparatus 10 will be explained with reference to the flowchart of FIG. 8.

The interpreting doctor operates the operating section 12 to input information on the interpreting doctor, like its name, and then input a command to start image-interpretation. Then, the processor section 11 reads the image record containing a first medical image P to be interpreted out of the image database 21.

From the read image record, the examination kind of the read medical image P is detected, and the interpreting doctor is identified by the information on the interpreting doctor. Corresponding to the identified interpreting doctor and the detected examination kind, a value of the standard interpretation time Ti is retrieved from the standard time database 23. Based on the retrieved standard interpretation time Ti, upper and lower limits of the normal range of the interpretation time are calculated. That is, the standard interpretation time and the normal range of the interpretation time are determined for each individual medical image P by the interpreting doctor and the examination kind as well.

After the upper and lower limits of the interpretation time are calculated, the image screen 18 containing the read medical image P is displayed on the monitor 14, whereas the result input screen 17 is displayed on the monitor 13. At this moment, the timer is reset and starts measuring the interpretation time in the present embodiment.

The interpreting doctor observes and examines the medical image P on the monitor 14, and input a conclusion obtained by the observation and examination, i.e. the interpretation result, by operating the mouse 12b on the monitor 13. Thereafter, the interpreting doctor clicks on the enter button 17a, to fix the input interpretation result. When the enter button 17a is clicked on, the timer stops measurement, and the measured time length is compared with the upper and lower limits.

When the measured interpretation time is longer than the lower limit and is shorter than the upper limit, i.e. within the normal range, the interpretation of the medical image P is judged to be valid, so the processor section 11 produces a report record, containing the input interpretation result, data indicating that the interpretation is adequate, and the judgment about the need for reinterpretation, which is based on the interpretation result and the judgment about the reliability. The report record is registered in the report database 22.

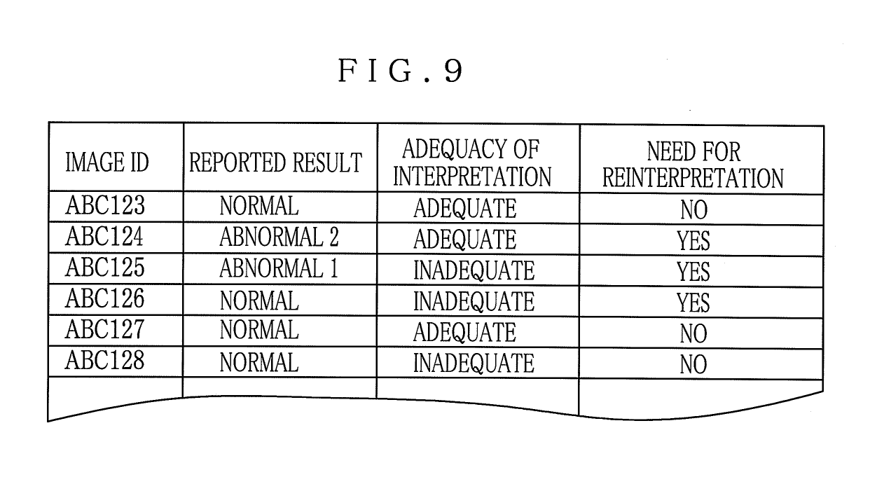

Accordingly, as shown for example in FIG. 9, if the interpretation result recites no abnormality and the interpretation time is within the normal range, like images with ID numbers “ABC123” and “ABC127”, the reports for these images record such a result that the image is normal, that the interpretation is adequate, and that the image needs not to be reinterpreted. On the other hand, if the interpretation result recites some abnormality and the interpretation time is within the normal range, like an image with ID number “ABC124”, the report for this image records such a result that an abnormality was found, that the interpretation is adequate, and that the image needs to be reinterpreted.

On the contrary, if the interpretation time is longer than the upper limit, the result is judged to be inadequate even if the interpretation result recites no abnormality, and it is judged that the image needs to be reinterpreted. That is, to say nothing of an image where an abnormality was found, like an image with ID number “ABC125”, an image, of which the interpretation result recites no abnormality but the interpretation is judged to be inadequate, like an image with ID number “ABC126”, the need of reinterpreting the image is recorded in the report.

If the interpretation time is shorter than the lower limit, at first the error alert screen 41 is displayed on the monitor 13, as shown in FIG. 6. Then the interpreting doctor confirms that the interpretation has no problem, and if so, clicks on the OK button 43. Then, the processor section 11 produces a report record on the basis of the interpretation result, including the judgment about the need for reinterpretation, in the same way as for the case where the interpretation time is within the normal range. That is, if the interpretation result recites no abnormality, it is judged that the image needs not to be reinterpreted. As the interpretation time being too short, however, the report records that the interpretation is inadequate, like an image with ID numbers “ABC128” in FIG. 9. It is alternatively possible to record that the interpretation is adequate when the OK button 43 is clicked on.

On the other hand, when the cancel button 44 is clicked on the error alert screen 41, it means that the enter button 17a is mistakenly clicked or the like, so the processor section 11 gets back to the step of resetting the timer to restart measuring the interpretation time, and executes the same procedures as above.

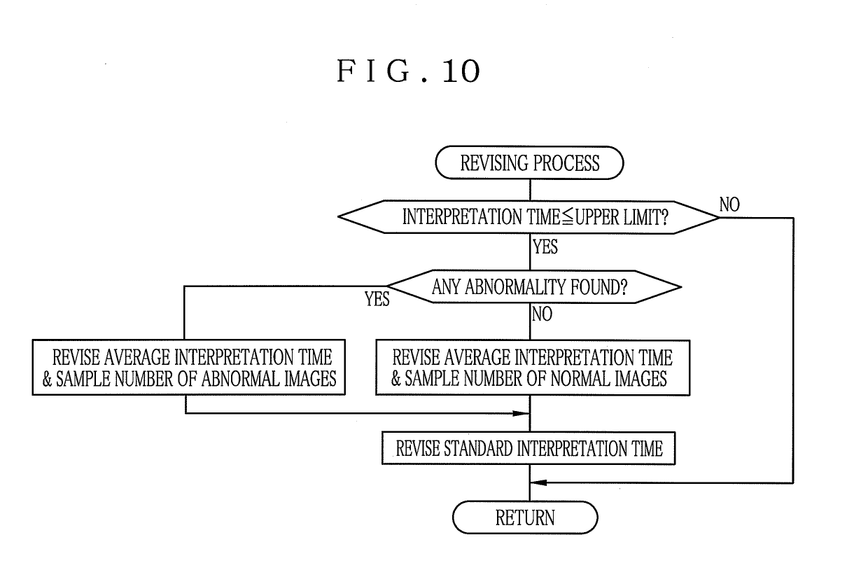

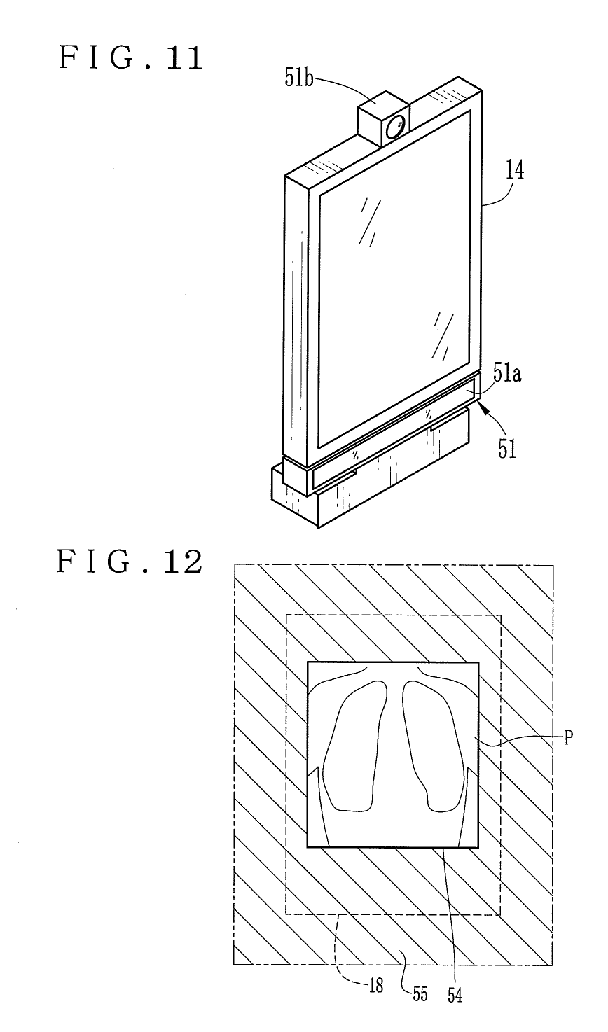

After the report record about one medical image P is produced and registered in the report database 22, the processor section 11 makes a revising process in a sequence as shown in FIG. 10, whereby the measured interpretation time is used to revise the corresponding standard interpretation time Ti, which is registered in the standard time database 23 in association with the represent interpreting doctor and the examination kind of the interpreted image, and was read out for comparison with the measured interpretation time. However, if the measured interpretation time is longer than the upper limit of the normal range of the standard interpretation time, the corresponding standard interpretation time Ti is not revised.

After revising the standard interpretation time Ti, the processor section 11 checks if the interpreting doctor completes interpreting all medical images to be interpreted. If not, the processor section 11 repeats the above-described procedures from the step of reading out another medical image from the image database 21.

During the above-described image-interpretation process, if the enter button 17a is not operated for such a long time that the measured interpretation time goes over the predetermined threshold length, the time-over alert screen 46 is displayed on the monitor 13, as shown in FIG. 7. In that case, the interpreting doctor or another operator clicks on the restart button 48 or the end button 49, to choose whether to restart the interpretation or terminate it.

When the restart button 48 is clicked on, the processor section 11 gets back to the step of resetting the timer to start measuring the interpretation time and makes the same processes as above. If the end button 49 is clicked on, the image-interpretation process is terminated instantly, making it possible for other apparatuses to refer to the medical image P displayed on the monitor 14 at that time.

As described so far, since the adequacy of interpretation is judged by the interpretation time, the reliability on the interpretation result and the judgment about the need for reinterpretation is improved. Since the judgment about the need for reinterpretation is based on the interpretation time as well as the interpretation result, even while the doctor who initially interpreted the images overlooked some abnormalities, they can be found by another doctor during the reinterpretation. In total, overlooking or other failures are reduced to the minimum.

It is preferably to provide the image-interpretation apparatus 10 with a function to notify another image-interpretation apparatus of a request for reinterpretation. In that case, the image-interpretation apparatus preferably displays the received request and automatically starts the process for reinterpreting those medical images which are needed to be reinterpreted.

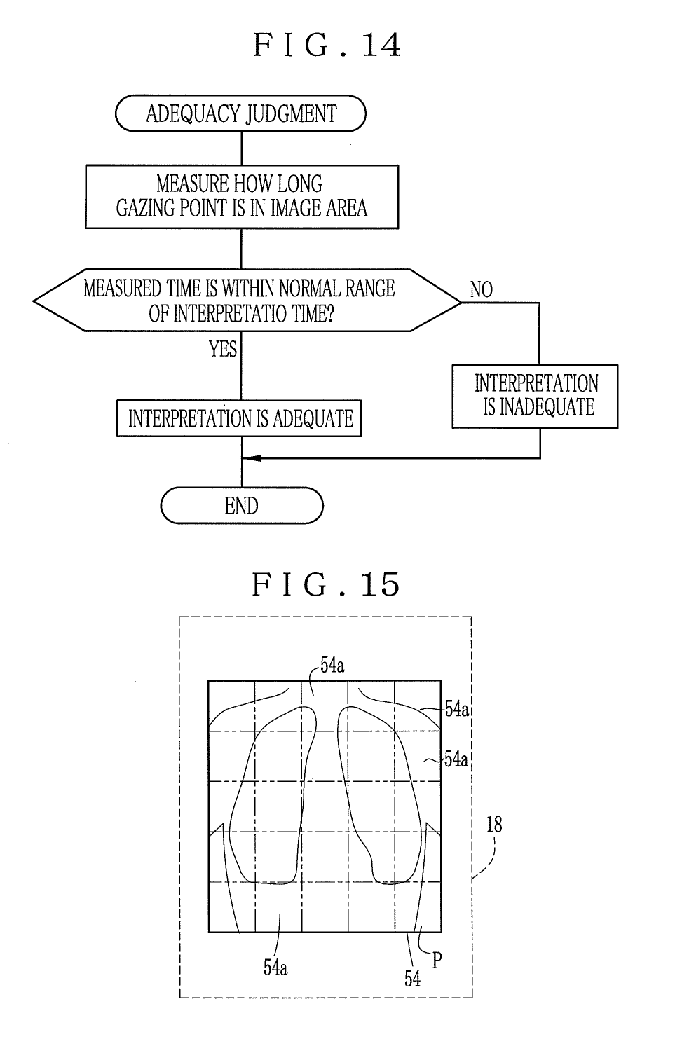

FIGS. 11 to 14 shows another embodiment, wherein a gazing point of the interpreting doctor is detected to measure how long the doctor's gazing point stays in an image area of a medical image to be interpreted, and the length of the time when the gazing point stayed in the image area is treated as an interpretation time. In the following embodiment, equivalent components to those of the first embodiment are designated by the same reference numerals, so the details of these components will be skipped.

A monitor 14 is provided with a gazing point detector 51 for detecting the gazing point of the interpreting doctor who is observing the monitor 14. The gazing point detector 51 includes an infrared light emitter 51a projecting an infrared ray toward eyes of the interpreting doctor, and a camera 51b imaging the doctor's eyes as being illuminated with the infrared ray, and is designed to detect the gazing point according to a well-known cornea light reflex method. It is possible to detect the gazing point using another method.

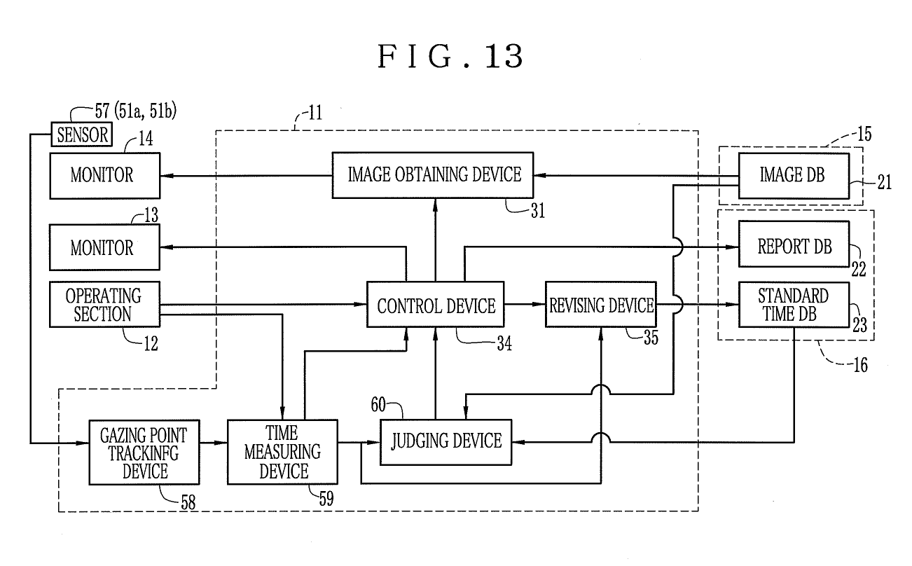

As shown in FIG. 12, an image display screen 18 has the predetermined image area 54 for displaying a medical image P. A coordinate system is defined on the image display screen 18, so that it can be detected whether the gazing point is in the image area 54 or in a peripheral area 55 outside the image area 54. Note that phantom lines in FIG. 12 are provided for graphical convenience.

As shown in FIG. 13, the infrared light emitter 51a and the camera 51b constitutes a sensor 57, and an output signal from the sensor 57, i.e. an image signal from the camera 51b, is fed to a gazing point tracking device 58. The gazing point tracking device 58 detects the gazing point as coordinates on the screen 18 on the basis of the image signal, and determines whether the gazing point is in the image area 54 or in the peripheral area 55.

A time measuring device 59 measures a total length of time when the doctor's gazing point is in the image area 54. Particularly, the time measuring device 59 counts up a timer value only while the gazing point is in the image area 54. The time length measured by the time measuring device 59 is output as an interpretation time to a judging device 60. The judging device 60 judges the adequacy of the interpretation by whether the interpretation time measured by the time measuring device 59 is within a normal range or not.

According to this embodiment, since the interpretation time is measured as an effective interpretation time for which the doctor actually observed the medical image P, it comes to be possible to make a stricter judgment about the adequacy of the interpretation by the time length taken for the interpretation. Needless to say, the standard interpretation time as a comparative for the measured time is suitably determined in accordance with the definition of the interpretation time.

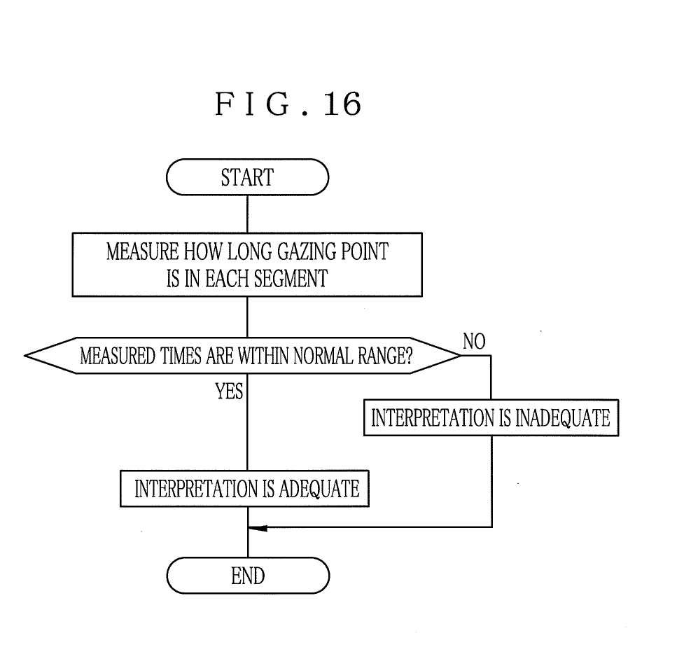

FIGS. 15 and 16 shows another embodiment, wherein an image area is divided into segments, so as to measure interpretation times in the individual segments, and judge the adequacy of the image-interpretation on the basis of the respective interpretation times measured in the segments. In the description, equivalent components to those of the above embodiments are designated by the same reference numerals, so the details of these components will be omitted.

In the present embodiment, an image area 54 for a medical image P is divided into matrix segments 54a. A gazing point discriminating device 58 determines which segment 54a the doctor's gazing point exists in. A time measuring device 59 is configured to measure individual time lengths, for which the gazing point exits in the respective segments 54a, and output the measured time lengths as interpretation times or effective interpretation times for the respective segments 54a to a judging device 60. In this embodiment, a normal range of the interpretation time for one segment 54a is predetermined, so the judging device 60 compares the respective interpretation times with the normal-range. If any of the measured interpretation times is out of the normal range, the judging device 60 judges the interpretation to be inadequate. In that case, the judging device 60 may judges that the medical image P needs to be reinterpreted.

The method of judging adequacy of the interpretation by the interpretation times measured in the respective segments 54a is not limited to the above embodiment. For example, the normal range of the interpretation time may vary from one segment 54a to another according to their locations. It is also possible to judge the interpretation as inadequate if there are any segments the gazing point did not enter. It is alternatively possible to record such position data in the report database 22 that indicate those segments where the interpretation times are longer than a reference value, or shorter than a reference value, so that the position data may be utilized for reinterpretation.

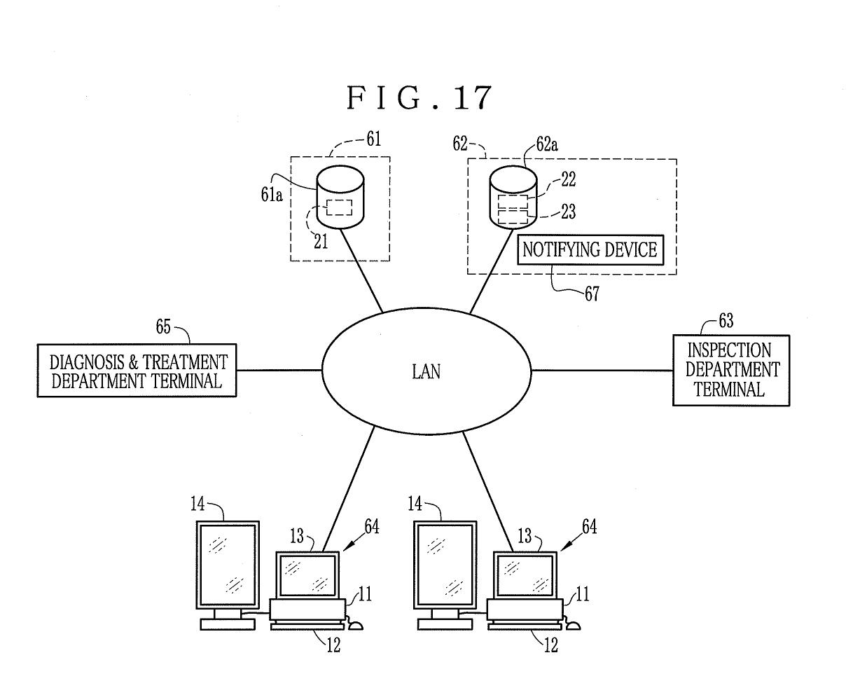

FIG. 17 shows a medical network system embodying an examination support system of the present invention, wherein equivalent components to those of the above embodiments are designated by the same reference numerals, so the details of these components will be omitted.

The medical network system is installed, for example, in a hospital, and constituted of an image server 61, a report server 62, an inspection department terminal 63 installed in a medical inspection department of the hospital, image-interpretation terminals 64 installed in an image-interpretation department, terminals 65 installed in diagnosis-and-treatment departments such as a surgery department and an inter-medicine department, wherein these terminals are interconnected through a LAN.

The servers 61 and 62 are each constituted of a computer having a communication device and a large-scale storage 61a or 62a. The storage 61a of the image server 61 stores an image database 21, whereas the storage 62a of the report server 62 stores a report database 22 and a standard time database 23.

The inspection department terminal 63 sends medical images as taken by modalities like CT scanners and MRI scanners to the image server 61, which adds an image ID and other tag data to each medical image and registers it in the image database 21.

The image-interpretation terminal 64 is constituted of a processor 11, an operating section 12, and monitors 13 and 14. The image-interpretation terminal 64 receives the medical images, which are registered in the image database 21 and are delivered from the image server 61, and displays the received medical images on the monitor 14. The image-interpretation terminal 64 produces a report record while measuring an interpretation time, and sends the report record and a measured interpretation time to the report server 62. The report server 62 adds the received report record to the report database 22, and revises the standard time database 23 with the measured interpretation time.

The report server 62 is further provided with a notifying device 67, which notifies another image-interpretation terminal of a request for reinterpretation and sends a command for executing the reinterpretation to that terminal. Upon receipt of the request for reinterpretation, the image-interpretation terminal 64 gets ready for reinterpretation of the requested medical image. Thus, the report server 62 constitutes a notifying apparatus.

According to the present embodiment, a couple of image-interpretation terminals 64 are installed in the image-interpretation department, so that one image-interpretation terminal 64 is informed of those medical images which are judged to need reinterpretation on the other image interpretation terminal 64.

Although the above embodiments have been described with respect to the medical network system inside a hospital, the present invention is applicable to a medical network system interconnected between hospitals, various medical facilities such as those for examination, etc. The above-described structures of the system are merely examples, and the present invention is not limited to the above-described structures, but the above-described processes and functions may be carried out appropriately by other terminals and servers. For example, the respective image-interpretation terminals may have a function of a notifying device.

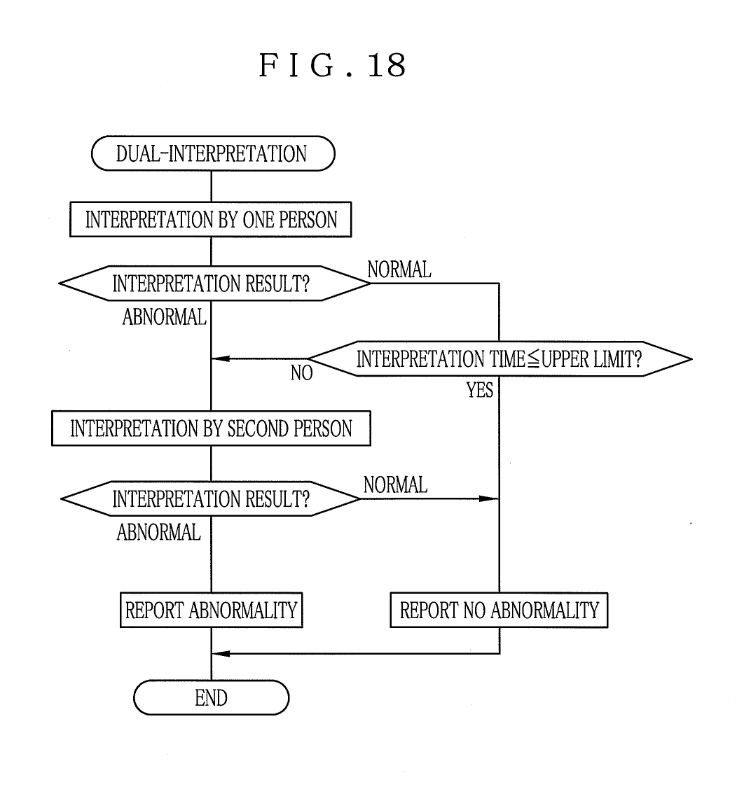

FIG. 18 shows a preferred embodiment of a dual-interpretation method, wherein two persons take charge of interpreting every designated image. Principally, those images in which some abnormality is found by one person are reinterpreted by the other person. If any abnormality is found also at the reinterpretation, the abnormality is reported. If not, no abnormality is reported as the interpretation result. However, if the time taken for the first person to interpret an image is over a predetermined upper limit, the second person reinterprets the image even while no abnormality was found by the first person.

The present invention is also applicable to such an image-interpretation method that a plural number of primary examiners individually interpret a same image so that the image is subjected to a secondary image-interpretation (reinterpretation) if any of the primary examiners judges it necessary. Moreover, the present invention is applicable to a case where the secondary image-interpretation is carried out beside the primary image-interpretation.

Although the examination support apparatus, method and system of the present invention have been described with respect to the preferred embodiments where the image-interpretation is carried out as an examination, the present invention is not to be limited to the image-interpretation, but is applicable to any examinations where an image to be examined is displayed and observed to input a result of the examination.

As shown in the above-described embodiments, the present invention may be embodied as a program or a storage medium storing that program.

Thus, the present invention is not to be limited to the above embodiments but, on the contrary, various modifications will be possible without departing from the scope of claims appended hereto.

What is claimed is:

1. An examination support apparatus for supporting an examiner to carry out an examination based on an image, said examination support apparatus comprising:
a display device for displaying an image to be examined;
an input device for inputting a result of the examination based on said displayed image;
a time measuring device for measuring a time taken for the examiner to complete the examination of said image; and
a first judging device for judging adequacy of the examination on the basis of the time measured by said time measuring device and a standard examination time estimated for the examination of said image.

2. An examination support apparatus as recited in claim 1, further comprising a second judging device for judging whether it is necessary to reexamine said image or not on the basis of the input result of the examination and a judgment about the adequacy of the examination by said first judging device.

3. An examination support apparatus as recited in claim 2, further comprising a notifying device for notifying another examination support apparatus that said second judging device judges it necessary to reexamine said image.

4. An examination support apparatus as recited in claim 1, further comprising a time storage device for storing standard examination times estimated for each individual examiner and each kind of examination, wherein said first judging device reads out the standard examination time for judgment from said time storage device according to the examiner of said image.

5. An examination support apparatus as recited in claim 4, further comprising a revising device for revising the standard examination times stored in said time storage device, said revising device revising the standard examination time as stored for the examiner and the kind of the examination of said image by use of the time measured by said time measuring device.

6. An examination support apparatus as recited in claim 1, further comprising a device for detecting a gazing point of the examiner and tracking whether the gazing point is in an image area of said image display device while said image is being displayed in said image area, wherein said time measuring device measures a total time length of the gazing point being in said image area during the examination of said image, and said first judging device uses the total time length as an effective examination time of said image for the judgment.

7. An examination support apparatus as recited in claim 1, further comprising a device for detecting a gazing point of the examiner and tracking which segment of an image area of said image display device the gazing point is in, while said image is being displayed in said image area, wherein said time measuring device measures a respective time length of the gazing point being in each of said segments of said image area during the examination of said image, and said first judging device makes the judgment by use of the respective time lengths measured.

8. An examination support apparatus as recited in claim 1, further comprising an alerting device for alerting an error in operation of said input device on the basis of the judgment by said first judging device.

9. An examination support apparatus as recited in claim 1, wherein said image to be examined is a medical image taken by a modality, and the examination is an image-interpretation.

10. An examination support system for supporting an examiner to carry out an examination based on an image, said examination support system comprising:
an image storage device storing a plurality of images to be examined;
a plurality of examination support apparatuses, each comprising a display device that seriatim obtains one image from said image storage device and displays said image; an input device for inputting a result of the examination based on said displayed image; a time measuring device for measuring a time taken for the examiner to complete the examination of said displayed image; a first judging device for judging adequacy of the examination on the basis of the time measured by said time measuring device and a standard examination time estimated for the examination of said image; and a second judging device for judging whether it is necessary to reexamine said image or not on the basis of the input result of the examination and a judgment about the adequacy by said first judging device; and
a report storage device storing reports relating to examinations based on respective images, each report including a result of examination based on each individual image and a judgment by said second judging device.

11. An examination support system as recited in claim 10, further comprising a notifying device that refers to each report stored in said report storage device and notifies another examination support apparatus of a need to reexamine said image.

12. An examination supporting method of supporting an examiner to carry out an examination based on an image, said method comprising steps of:
displaying an image to be examined;
measuring a time taken for the examiner to complete the examination of said displayed image;
estimating a standard examination time for the examination of said displayed image; and
judging adequacy of the examination on the basis of the measured time and said standard examination time.

13. An examination supporting method as recited in claim 12, further comprising steps of:
inputting a result of the examination based on said displayed image;
judging whether it is necessary to reexamine said image or not on the basis of the input result of the examination and a judgment about the adequacy of the examination; and
producing a report on the examination based on said image, said report including the result of the examination and a judgment about need for reexamination of said image.

14. An examination supporting method as recited in claim 12, wherein said standard examination time is estimated for each individual examiner and each kind of examination, and is revised on the basis of the measured time.

15. An examination supporting method as recited in claim 12, further comprising steps of detecting a gazing point of the examiner and tracking whether the gazing point is in an image area in which said image is displayed, wherein a total time length of the gazing point being in said image area is measured during the examination of said image, and the total time length is compared with said standard examination time for the judgment about the adequacy of the examination.
